(19) United States
(12) Patent Application Publication
(10) Pub. No.: US 2010/0208382 A1
(43) Pub. Date: Aug. 19, 2010

(54) RECORDING MEDIUM DRIVE AND METHOD FOR CONTROLLING TEMPERATURE OF RAMP MEMBER FOR RECORDING MEDIUM DRIVE

(75) Inventor: Tetsuya SAKABE, Tendou-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Toshiba Storage Device Corporation, Tokyo (JP)

(21) Appl. No.: 12/772,072

(22) Filed: Apr. 30, 2010

Related U.S. Application Data
(63) Continuation of application No. PCT/JP2007/071505, filed on Nov. 5, 2007.

(51) Int. Cl. G11B 19/02

(52) U.S. Cl. 360/69; G9B/19.001

(57) ABSTRACT

According to one embodiment, a recording medium drive includes a housing, a recording medium, a head actuator member stored in the housing reciprocatably about a shaft, and facing the recording medium at one end, a load tab on the end of the head actuator member, a ramp member fixed in the housing at an outer side of the recording medium, and defining a sliding surface that receives sliding of the load tab, a heater increasing a temperature of the ramp member based on a supplied driving current, a temperature sensor detecting a temperature inside the housing and outputting temperature information, a memory storing profiles of the driving current each set for a predetermined temperature range, and a control circuit supplying a predetermined value of driving current to the heater based on one of the profiles corresponding to the temperature information.

### CROSS-REFERENCE TO RELATED APPLICATIONS

This application is a continuation of PCT international application Ser. No. PCT/JP2007/071505 filed on Nov. 5, 2007 which designates the United States, the entire contents of which are incorporated herein by reference.

### BACKGROUND

1. Field

One embodiment of the invention relates to a recording medium drive such as a hard disk drive (HDD).

2. Description of the Related Art

A ramp load system has been widely know in the HDD field. A load tab is provided on an end of a carriage in the ramp load system. A ramp member is arranged outside of a magnetic disk on a load tab moving path. The load tab slides on the ramp member when loading and unloading the carriage. The resulting slide friction causes wear dust. When the wear dust deposits, for example, on a surface of the magnetic disk, floating characteristics of a flying head slider are substantially deteriorated.

For example, as disclosed in Japanese Patent Application Publication (KOKAI) No. 2006-338807, the inner temperature of an HDD is measured before loading or unloading is executed. When the measured temperature does not reach a set temperature, electrical current is applied to a heater, and the heater raises the temperature of the ramp member. The measurement of the temperature and the application of current to the heater are thus repeated alternately, that is, feedback control is performed. As the temperature of the ramp member rises, friction force between the load tab and the ramp member decreases, so that formation of wear dust can be suppressed. Other examples of conventional technology comprise Japanese Patent Application Publication (KOKAI) No. 2002-367313 and Japanese Patent Application Publication (KOKAI) No. S54-82212.

To increase the temperature inside the HDD, the temperature has to be measured repeatedly according to Japanese Patent Application Publication (KOKAI) No. 2006-338807. Therefore, for example, a predetermined value of current has to be applied repeatedly. Because of this, it takes time before loading or unloading is started. For example, it takes time to start up the HDD. Such time makes an HDD user feel uncomfortable. On the other hand, if a large current value is supplied at one time, while the temperature of the ramp member is raised in a relatively short period of time, formation of dust cannot be suppressed.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view of an internal structure of a hard disk drive (HDD) as an example of a recording medium drive according to an embodiment of the invention;

FIG. 2 is an exemplary partially enlarged perspective view of a configuration of a ramp member in the embodiment;

FIG. 3 is an exemplary enlarged plan view of the configuration of the ramp member in the embodiment;

FIG. 4 is an exemplary block diagram of a control system of the HDD in the embodiment;

FIG. 5 is an exemplary table of electric current profiles in the embodiment;

FIG. 6 is an exemplary graph of a first profile in the embodiment;

FIG. 7 is an exemplary graph of a second profile in the embodiment;

FIG. 8 is an exemplary graph of a third profile in the embodiment;

FIG. 9 is an exemplary graph of a fourth profile in the embodiment;

FIG. 10 is an exemplary graph of a fifth profile in the embodiment;

FIG. 11 is an exemplary graph of a sixth profile in the embodiment; and

FIG. 12 is an exemplary flowchart of processing performed by a control circuit in the embodiment.

### DETAILED DESCRIPTION

Various embodiments according to the invention will be described hereinafter with reference to the accompanying drawings. In general, according to one embodiment of the invention, a recording medium drive includes a housing, a recording medium configured to be incorporated in the housing, a head actuator member stored in the housing, reciprocatably about a shaft, and configured to face the recording medium at one end, a load tab configured to be provided on the end of the head actuator member, a ramp member configured to be fixed in the housing at an outer side of the recording medium, and define a sliding surface that receives sliding of the load tab, a heater stored in the housing and configured to increase a temperature of the ramp member based on a supplied driving current, a temperature sensor stored in the housing, and configured to detect a temperature inside the housing and output temperature information, a memory configured to store therein profiles of the driving current that are each set for a predetermined temperature range and used to increase the temperature of the ramp member up to a target temperature, and a control circuit configured to be connected to the heater and supply a predetermined value of driving current to the heater based on one of the profiles corresponding to the temperature information output from the temperature sensor.

According to another embodiment of the invention, a recording medium drive includes a housing, a recording medium configured to be incorporated in the housing, a head actuator member configured to make an end thereof move from a waiting position away from the recording medium to a floating position facing the recording medium based on reciprocation about a shaft when being loaded, a load tab configured to be provided on the end of the head actuator, a ramp member configured to be fixed in the housing at an outer side of the recording medium and define a sliding surface that receives sliding of the load tab when the head actuator member is loaded, a temperature sensor configured to be incorporated in the housing, detect a temperature inside the housing, and output temperature information, a memory configured to store therein temperature history information that specifies a past temperature inside the housing, and a control circuit configured to determine whether to load the head actuator member based on the temperature history information.

According to still another embodiment of the invention, a ramp member temperature controlling method for a recording medium drive includes detecting a temperature inside a housing by a temperature sensor incorporated in the housing, and increasing a temperature of a ramp member configured to define a sliding surface that receives sliding of a load tab up to a target temperature by supplying a predetermined driving current to a heater based on a predetermined profile specified correspondingly to the temperature thus detected.

According to still another embodiment of the invention, a ramp member temperature controlling method for a recording medium drive includes acquiring temperature history information that specifies a past temperature detected by a temperature sensor stored in a housing, and determining whether to load a load tab from a waiting position to a floating position based on the temperature history information, the waiting position being a position at which the load tab is received on a ramp member configured to define a sliding surface that receives sliding of the load tab, and a floating position being a position at which the load tab faces the recording medium.

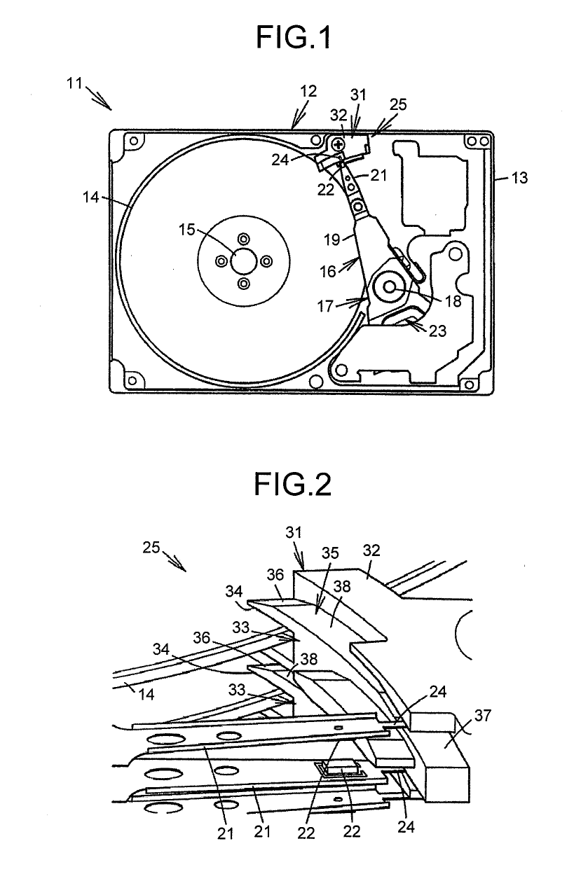

FIG. 1 schematically illustrates an internal structure of a hard disk drive (HDD) 11 as an example of a recording medium drive according to an embodiment of the invention. The HDD 11 comprises a housing 12. The housing 12 comprises a box-shaped base 13 and a cover (not illustrated). The base 13 defines, for example, a flat rectangular parallelepiped internal space, i.e., a housing space. The base 13 may be formed by casting a metallic material such as aluminum. The cover is connected to an opening of the base 13. The housing space is sealed at a portion between the cover and the base 13. The cover may be formed by, for example, pressing a piece of plate.

In the housing space, at least one magnetic disk 14 as a recording medium is housed. The magnetic disk 14 is mounted on the rotating shaft of a spindle motor 15. The spindle motor 15 can rotate the magnetic disk 14 at high speed of 5400 rpm, 7200 rpm, 10000 rpm, and 15000 rpm, for example.

In the housing space, a head actuator member, i.e., a carriage 16 is further housed. The carriage 16 comprises a carriage block 17. The carriage block 17 is rotatably connected to a shaft 18 that extends in a vertical direction. With the carriage block 17, a plurality of carriage arms 19 that extends from the shaft 18 in a horizontal direction is integrated. The carriage block 17 may be formed by, for example, extruding aluminum.

A head suspension 21 is attached to the end of each of the carriage arms 19. The head suspension 21 extends from the end of the carriage arm 19 toward the front. A flexure is attached to the head suspension 21. On the surface of the flexure at the end of the head suspension 21, a flying head slider 22 is mounted. On the flexure, a gimbal spring is integrated. This gimbal spring enables the flying head slider 22 to change the position with respect to the head suspension 21.

When an air flow is produced on the surface of the magnetic disk 14 by rotation of the magnetic disk 14, positive pressure, i.e., buoyancy, and negative pressure act on the flying head slider 22 due to the air flow. When the buoyancy and the negative pressure, and a pressing force of the head suspension 21 are in balance, the flying head slider 22 can keep floating at relatively high stiffness during the rotation of the magnetic disk 14.

A voice coil motor (VCM) 23 is connected to the carriage block 17. By the action of the VCM 23, the carriage block 17 can rotate about the shaft 18. Such rotation of the carriage block 17 enables reciprocation of the carriage arm 19 and the head suspension 21. When the carriage arm 19 reciprocates about the shaft 18 while the flying head slider 22 is floating, the flying head slider 22 can traverse the surface of the magnetic disk 14 in a radial direction. Based on such movement of the flying head slider 22, an electromagnetic transducer device is positioned with respect to the targeted recording track.

At the end of the head suspension 21, a load tab 24 extending from the end of the head suspension 21 toward the front is fixed. The load tab 24 is made of a metallic material, such as stainless steel. The load tab 24 can move in the radial direction of the magnetic disk 14 based on reciprocation of the carriage arm 19. On the moving path of the load tab 24, a ramp member 25 is disposed at an outer side of the magnetic disk 14. The ramp member 25 receives the load tab 24. The ramp member 25 and the load tab 24 in combination serve as a so-called loading-unloading mechanism.

The ramp member 25 comprises a ramp body 31 made by molding a rigid plastic material, for example. The ramp body 31 comprises a mounting base 32 fixed to the bottom plate of the base 13 at an outer side of the magnetic disk 14. The mounting base 32 is fixed to the base 13 optionally with, for example, a screw. As illustrated in FIG. 2, projections 33 projecting along horizontal planes toward the shaft 18 of the carriage 16 are provided to the mounting base 32. The projections 33 are integrated to the mounting base 32 by, for example, integral molding. In the mounting base 32 and the projections 33, receiving grooves 34 are formed. Each receiving groove 34 is configured to receive the magnetic disk 14.

The upper surface and the lower surface of the projections 33 define sliding surfaces 35, 35. Each sliding surface 35 extends along an arc having a predetermined curvature about the axis of the shaft 18. Therefore, reciprocation of the carriage 16 about the shaft 18 causes the load tab 24 to move on the sliding surface 35 from the inner end to the outer end. Meanwhile, the load tab 24 slides on the sliding surface 35. In this manner, the sliding surface 35 constitutes a path of the load tab 24.

The sliding surface 35 comprises a first sliding surface 36 extending outward in the radial direction of the magnetic disk 14 from the inner end of the sliding surface 35. The first sliding surface 36 is arranged gradually away from the surface of the magnetic disk 14 as the first sliding surface 36 extends outward in the radial direction of the magnetic disk 14. On the outer side of the first sliding surface 36, a second sliding surface 38 extending toward a recess 37 is provided. The second sliding surface 38 is connected to the uppermost end, namely, the outer end, of the first sliding surface 36. While the carriage 16 retreats, the recess 37 receives the load tab 24.

A lubricant may be applied to the sliding surface 35. As the lubricant, perfluoropolyether may be used, for example. The lubricant is applied by, for example, immersing the ramp member 25 in a solution containing perfluoropolyether. Alternatively, for example, the rigid plastic material may be immersed in a lubricant prior to molding of the ramp member 25. Such a lubricant contributes to prevent friction between the load tab 24 and the sliding surface 35 as much as possible.

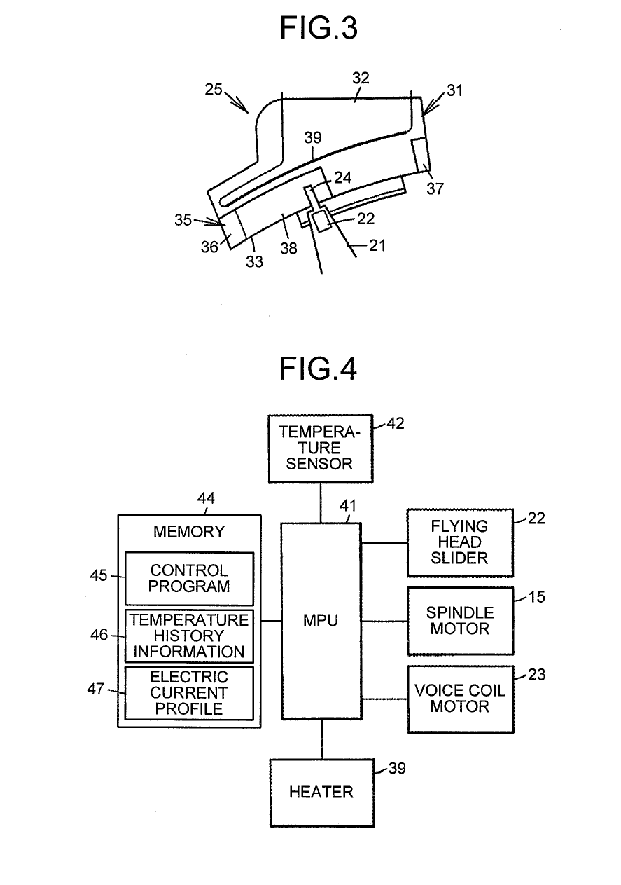

As illustrated in FIG. 3, the ramp member 25 comprises a heater 39 embedded in the ramp body 31. As the heater 39, a heating wire is used, for example. The heating wire is made of a metallic material, such as tungsten (W). In the ramp body 31, the heating wire extends along the sliding surface 35 of each projection 33. The distance between the sliding surface 35 and the heating wire maybe the same from the inner end through the outer end of the sliding surface 35. The heater 39 thus configured is supplied with a predetermined driving current. The distribution of the driving current causes the heater 39 to produce heat. The heater 39 thus raises the temperature of the ramp body 31.

As illustrated in FIG. 4, coupled to the flying head slider 22 is a control circuit, namely, a microprocessor unit (MPU) 41. In reading out magnetic information, the MPU 41 supplies a sense current to a read device in an electromagnetic transducer device incorporated in the flying head slider 22. In writing in magnetic information, the MPU 41 supplies a write current to a write device in the electromagnetic transducer device. In a similar manner, the spindle motor 15 and the voice coil motor 23 are coupled to the MPU 41. The MPU 41 supplies a driving current to the spindle motor 15 and the voice coil motor 23.

Coupled also to the MPU 41 is a temperature sensor 42 that senses the temperature inside the housing 12. The temperature sensor 42 can output temperature information specifying the temperature inside the housing 12 to the MPU 41. As the temperature sensor 42, a temperature sensor that is conventionally arranged in the housing 12 can be used. To the MPU 41, the heater 39 is coupled. The MPU 41 supplies a driving current to the heater 39 based on electric current profiles, which will be described later.

Coupled also to the MPU 41 is a memory 44. As the memory 44, a nonvolatile memory is used, for example. The MPU 41 performs various processing operations based on a control program 45 stored in the memory 44. As the MPU 41, a digital signal processor (DSP) maybe used, for example, as long as the MPU 41 functions as a so-called hard disk controller (HDC).

The memory 44 also stores therein temperature history information 46. The temperature history information 46 contains a plurality of pieces of temperature information output from the temperature sensor 42 in the past. To establish the temperature history information 46, the memory 44 receives temperature information from the temperature sensor 42. The temperature information is input every time the HDD 11 is started, for example. When the latest temperature information is input in the memory 44, the latest temperature information is written over the earliest temperature information. In this manner, the temperature history information 46 contains 64 pieces of the latest temperature information, for example.

The memory 44 also stores therein an electric current profile 47. The electric current profile 47 specify a driving current profile of the heater 39 to raise the temperature of the ramp member 25 for each temperature range inside the housing 12 up to a target temperature. In this example, the target temperature is set to +25 (° C.), for example. The profiles also specify the current value and the application time of the driving current. The current value and the application time are set based on actual measurements. The MPU 41 supplies a predetermined driving current to the heater 39 according to a certain electric current profile 47.

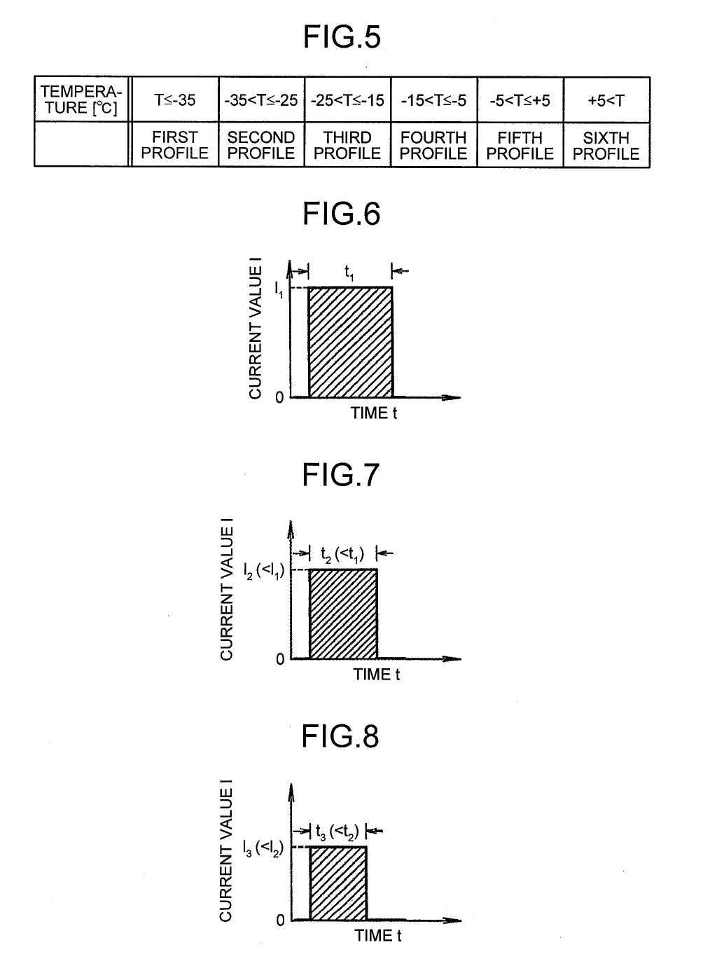

As illustrated in FIG. 5, the electric current profile 47 comprise, for example, six (first to sixth) profiles set for respective temperature ranges. The first profile is selected if the temperature T inside the housing 12 is equal to or less than −35 (° C.). The second profile is selected if the temperature T is greater than −35 (° C.) and equal to or less than −25 (° C.) . The third profile is selected if the temperature T is greater than −25 (° C.) and equal to or less than −15 (° C.). The fourth profile is selected if the temperature T is greater than −15 (° C.) and equal to or less than −5 (° C.). The fifth profile is selected if the temperature T is greater than −5 (° C.) and equal to or less than +5 (° C.). The sixth profile is selected if the temperature T is greater than +5 (° C.).

As represented in FIG. 6, the first profile specifies a fixed current value I₁ and a certain application time t₁. As mentioned above, the current value I₁ and the application time t₁ are set based on actual measurements. In this example, the upper limits of the current value I₁ and the application time t₁ thereof that are allowable for the ramp body 31 are set. The upper limits are set depending on the material of the ramp body 31. By thus setting the upper limits, melting of the ramp body 31 due to a sharp rise in the temperature of the heater 39 is prevented without fail. Accordingly, dust formation due to melting is avoided. With the first profile, the temperature of the ramp body 31 can be raised up to a target temperature of +25 (° C.) in the shortest time t₁.

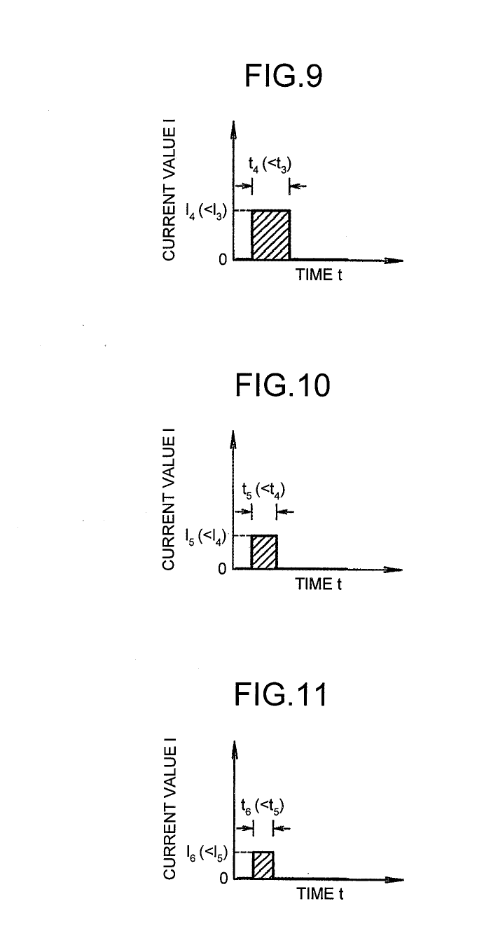

FIGS. 7 to 11 represent the second to the sixth profiles, respectively. The first to the sixth profiles specify smaller current values I for higher temperature ranges. In the same manner as the first profile described above, the second to the sixth profiles may specify fixed current values I₂ to I₆. The second to the sixth profiles specify the upper limits of the current values I₂ to I₆ and application times t₂ to t₆ thereof, respectively, that are allowable for the ramp body 31. With the second to the sixth profiles, the temperature of the ramp body 31 can be raised up to the target temperature of +25 (° C.) in the shortest times t₂ to t₆, respectively.

Alternatively, the first to the sixth profiles may specify unfixed current values I₁ to I₆. For example, a current value I that exceeds the maximum current value I allowable for the ramp body 31 may be set, as long as the application time t of the current value I exceeding the maximum current value I is adjusted. Specifically, the application time t of the current value I exceeding the maximum current value I needs to be shortened. Alternatively, the current values I₁ to I₆ may gradually decrease or increase with the passage of the application times t₁ to t₆, for example. With the current values I₁ to I₆ or the application time t₁ to t₆ adjusted, melting of the ramp body 31 is prevented without fail. Consequently, gas generation due to melting is avoided.

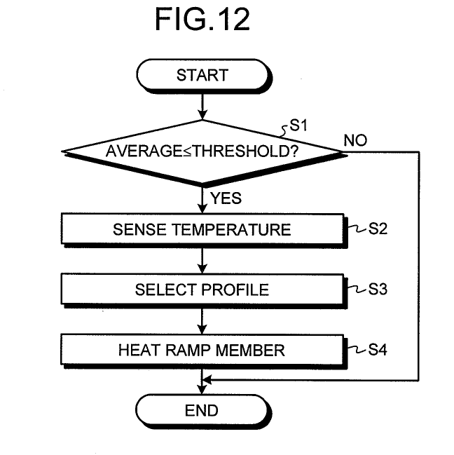

The following description will be made supposing that the HDD 11 is being started. The MPU 41 first determines whether to load the carriage 16. As illustrated in FIG. 12, the MPU 41 calculates an average temperature inside the housing 12 based on all pieces of the temperature history information 46 at S1. If the calculated average temperature exceeds a predetermined threshold (NO in S1), for example, the MPU 41 ends the determination process. The predetermined threshold is set at +5 (° C.), for example. As a result, the MPU 41 allows loading of the carriage 16. Subsequently, the MPU 41 executes read processing of magnetic information or write processing of magnetic information.

In executing read processing or write processing of magnetic information, the MPU 41 specifies a predetermined value of driving current to the spindle motor 15. The driving current is supplied from a predetermined power source, for example. Consequently, the spindle motor 15 rotates at a fixed rotation rate, and the magnetic disk 14 rotates accordingly. When the rotation of the magnetic disk 14 reaches a steady state, the MPU 41 supplies a predetermined value of driving current to the voice coil motor 23. The carriage 16 is positioned at its waiting position. The recess 37 in the ramp member 25 receives the load tab 24. The carriage 16 starts reciprocating in the reverse direction, whereby loading of the carriage 16 toward the magnetic disk 14 is started.

The load tab 24 moves from the recess 37 toward the second sliding surface 38. The load tab 24 then passes the second sliding surface 38 and reaches the first sliding surface 36. The load tab 24 then goes down along the first sliding surface 36. The flying head slider 22 gradually comes close to the surface of the magnetic disk 14. When a sufficient air flow from the magnetic disk 14 acts on the flying head slider 22, the flying head slider 22 gets buoyancy. Between the flying head slider 22 and the surface of the magnetic disk 14, an air bearing is formed. Subsequently, once the load tab 24 leaves the first sliding surface 36, the flying head slider 22 keeps floating with the air bearing thus effected. In this manner, the carriage 16 is positioned at the floating position.

While the flying head slider 22 is floating, the electromagnetic transducer device in the flying head slider 22 executes reading and writing of magnetic information. When the reading or writing of magnetic information is completed, the MPU 41 retracts the flying head slider 22 from the magnetic disk 14. To execute retraction, the MPU 41 supplies a predetermined value of driving current to the voice coil motor 23. The carriage 16 reciprocates in a forward direction about the shaft 18. As a result, the end of the head suspension 21 moves toward the outer rim of the magnetic disk 14. The load tab 24 moves outward in the radial direction of the magnetic disk 14.

In response to reciprocation of the carriage 16 about the shaft 18, the load tab 24 comes in contact with the sliding surface 35 of the ramp member 25. The load tab 24 then goes up along the first sliding surface 36. As the load tab 24 goes up along the first sliding surface 36, the flying head slider 22 is lifted from the surface of the magnetic disk 14. Consequently, the buoyancy and the negative pressure acting on the flying head slider 22 disappear. The load tab 24 causes the flying head slider 22 to be supported on the ramp member 25. At this point, the MPU 41 stops rotation of the magnetic disk 14.

The carriage 16 keeps reciprocating thereafter, whereby the load tab 24 passes the second sliding surface 38 on the ramp member 25 and reaches the recess 37. In this manner, the load tab 24 slides on the sliding surface 35 from the outer end to the inner end. Subsequently, the MPU 41 stops supplying the driving current to the voice coil motor 23. The carriage 16 then stops reciprocating, and is positioned at its waiting position. The load tab 24 is retained in the recess 37. The write processing or the read processing of magnetic information is thus completed.

By contrast, if the calculated average temperature is equal to or less than the predetermined threshold (YES in S1), e.g., if the average temperature is +3 (° C.), heating processing of the ramp body 31 is executed. Prior to the heating processing, the MPU 41 causes the temperature sensor 42 to operate at S2. The temperature sensor 42 senses the current temperature inside the housing 12. The sensing of the temperature is carried out for a plurality of times, for example. The sensing for a plurality of times suppresses temperature errors as much as possible. The average of the sensed temperatures, e.g., +1 (° C.), is sensed as the current temperature. When the current temperature inside the housing 12 is thus sensed, the temperature sensor 42 outputs temperature information specifying the current temperature to the MPU 41.

The MPU 41 selects an optimum electric current profile 47 at S3 for the temperature specified by the temperature information. In this example, the fifth profile is selected for the current temperature of +1 (° C.). The MPU 41 supplies a driving current to the heater 39 according to the fifth profile. The predetermined current value I₅ of the driving current is supplied for the predetermined application time t₅. The heater 39 produces heat, thereby heating the ramp body 31 (S4). As a result, the temperature of the ramp body 31, that is, the temperature of the sliding surface 35, is raised up to the target temperature of +25 (° C.). Subsequently, as in the same manner as described above, read processing of magnetic information or write processing of magnetic information is executed.

In the thus configured HDD 11, the ramp body 31 is heated prior to loading of the carriage 16. The sliding surface 35 is heated to reach or exceed a predetermined temperature. As a result, despite contact with the load tab 24, dust formation on the sliding surface 35 of the ramp body 31 is suppressed. To heat the ramp body 31, the optimum electric current profile 47 for the temperature inside the housing 12 is selected. The current values I₁ to I₆ and the application times t₁ to t₆ of the electric current profile 47 are set based on actual measurements. The current value I is set to a maximum value depending on the material of the ramp body 31, for example. Therefore, after the temperature of the ramp body 31 is raised, no additional measurement of the temperature inside the housing 12 is required. Furthermore, there is no need to sense the temperature of the ramp body 31. The temperature of the ramp body 31 is raised up to the target temperature in the shortest time. The temperature of the ramp body 31 is thus efficiently adjusted. The startup time of the HDD 11 is shortened.

Further, prior to the sensing of the temperature inside the housing 12, the past average temperature inside the housing 12 is calculated based on the temperature history information 46. Whether heating processing is required for the ramp body 31 is determined based on the average temperature. If the heating processing is determined to be unnecessary, the startup time of the HDD 11 is further shortened. When the HDD 11 is incorporated in non-portable electronic equipment, such as a server computer, the HDD 11 will experience no significant changes in ambient temperature. The approximate current temperature inside the housing 12 is predicted based on the average temperature, leaving no need to sense the temperature of the ramp body 31. Therefore, calculation of the average temperature is effective particularly in such cases. By contrast, when the HDD 11 is incorporated in portable electronic equipment, such as a notebook personal computer or a car navigation system, reference to the temperature history information 46 can be omitted.

The MPU 41 may determine whether to unload the carriage 16 not only in the startup of the HDD 11 but also during a time period when the HDD 11 is not running. To make unloading determination, in a similar manner to what is described above, the MPU 41 begins processing with calculation of the average temperature inside the housing 12 based on the temperature history information 46. The similar processing to what is described above then follows. Further, the current values I₁ to I₆ in the electric current profile 47 can be changed in a desirable manner as long as the shortest times t₁ to t₆ are set.

Moreover, a counter-electromotive current generated when the spindle motor 15 is stopped may be used to drive the heater 39. For example, when electronic equipment is shifted to a power save mode, the carriage 16 reciprocates to retreat from above the magnetic disk 14 to above the ramp member 25. At this point, counter-electromotive force is generated in the spindle motor 15. The counter-electromotive force causes the spindle motor 15 to supply a counter-electromotive current to the heater 39, thereby eliminating the need for driving current supply through the arithmetic processing of the MPU 41. The ramp body 31 is thus heated in quite a short period of time.

The recording medium drive determines whether to load the head actuator member based on the temperature history information. The temperature history information specifies the past temperature inside the housing; accordingly, the approximate present temperature inside the housing can be predicted. When the determination whether to execute loading is made based on the past temperature, the present temperature of the ramp member needs not to be measured in the housing. Formation of dust on the sliding surface of the ramp member can be thus suppressed. Moreover, time required for measuring the temperature can be saved, thereby further shortening the startup time of the recording medium drive. Such a recording medium drive is effectively applied to an electronic device that is arranged in, for example, an environment having a small change in temperature.

In such a recording medium drive, the control circuit calculates an average temperature inside the housing based on the temperature history information, and allows loading of the head actuator member when detecting that the average temperature exceeds a certain threshold. Calculation of the average temperature enables prediction of the approximate present temperature inside the housing in the recording medium drive arranged in an environment having a small change in temperature. Accordingly, it is predictable that the sliding surface of the ramp member is set higher than a certain temperature, without detecting the temperature of the ramp member, when the average temperature exceeds the certain threshold. Executing loading of the head actuator member under such a condition suppresses formation of dust on the sliding surface of the ramp member.

By the temperature controlling method, in the same manner as described above, determination whether to load the load tab is made based on the temperature history information. The temperature history information specifies the past temperature inside the housing; accordingly, the approximate present temperature inside the housing can be predicted. Therefore, the temperature of the ramp member needs not to be detected. When the determination whether to execute loading is made based on the past temperature, the present temperature inside the housing needs not to be measured. Formation of dust on the sliding surface of the ramp member can be thus suppressed. Moreover, time required for measuring the temperature can be saved, thereby further shortening the startup time of the recording medium drive. Such a recording medium drive is effectively applied to an electronic device that is arranged in, for example, an environment having a small change in temperature.

Calculation of the average temperature enables prediction of the approximate present temperature inside the housing in the recording medium drive arranged in an environment having a small change in temperature. The temperature of the ramp member, therefore, needs not to be detected. Accordingly, it is predictable that the temperature of the sliding surface of the ramp member is set higher than a certain temperature when the average temperature exceeds the certain threshold. Executing loading of the load tab under such a condition suppresses formation of wear dust on the sliding surface of the ramp member.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A recording medium drive comprising:
a housing;
a recording medium in the housing;
a head actuator in the housing, configured to swing around a shaft, and to face the recording medium at a first end;
a load tab on the end of the head actuator;
a ramp attached to the inside of the housing at an outer side of the recording medium, and comprising a sliding surface configured to receive sliding of the load tab thereon;
a heater in the housing, configured to increase a temperature of the ramp based on a driving current;
a temperature sensor in the housing, configured to detect a temperature inside the housing and to output temperature information;
a memory configured to store profiles of the driving current for a plurality of predetermined temperature ranges and used to increase the temperature of the ramp to a target temperature; and
a controller connected to the heater and configured to supply a predetermined driving current to the heater based on one of the profile corresponding to the temperature information from the temperature sensor.

2. The recording medium drive of claim 1, wherein the predetermined current in the profiles decreases as the predetermined temperature range increases.

3. The recording medium drive of claim 1, wherein a current amount and an application time of the driving current are set based on an actual measurement in the profiles.

4. A ramp temperature controlling method for a recording medium drive, the method comprising:
detecting a temperature inside a housing by a temperature sensor in the housing; and
increasing a temperature of a ramp to a target temperature by supplying a predetermined driving current to a heater based on a predetermined profile corresponding to the detected temperature,
wherein the ramp comprises a sliding surface configured to receive sliding of a load tab.

5. The method of claim 4, wherein the profiles correspond to temperature ranges.

6. The method of claim 4, wherein the heater is driven by a counter-electromotive current when a spindle motor configured to rotatably drive the recording medium stops.

7. A ramp temperature controlling method for a recording medium drive, the method comprising:
acquiring temperature history information comprising a temperature in the past associated with a present temperature detected by a temperature sensor in a housing; and
determining whether to load a load tab from a standby position to a floating position based on the temperature history information,
wherein the standby position is a position where a ramp is configured to receive sliding of the load tab on a sliding surface of the ramp, and a floating position being a position where the load tab is configured to face the recording medium.

8. The method according to claim 7, wherein the determining comprises
calculating an average temperature inside the housing based on the temperature history information; and
allowing loading of the load tab when the average temperature exceeds a predetermined threshold.
